(19) United States
(12) Patent Application Publication
(10) Pub. No.: US 2011/0082981 A1
(43) Pub. Date: Apr. 7, 2011

(54) MULTIPROCESSING CIRCUIT WITH CACHE CIRCUITS THAT ALLOW WRITING TO NOT PREVIOUSLY LOADED CACHE LINES

(75) Inventors: Jan Hoogerbrugge, Helmond (NL); Andrei Sergeevich Terechko, Eindhoven (NL)

(73) Assignee: NXP B.V., Eindhoven (NL)

(21) Appl. No.: 12/988,669

(22) PCT Filed: Apr. 22, 2009
(86) PCT No.: PCT/IB2009/051649

§ 371 Date: Oct. 20, 2010

(30) Foreign Application Priority Data
Apr. 22, 2008 (EP) 08103650.1

(51) Int. Cl. G06F 12/08

(52) U.S. Cl. 711/119; 711/E12.017

(57) ABSTRACT

Data is processed using a first and second processing circuit (12) coupled to a background memory (10) via a first and second cache circuit (14, 14′) respectively. Each cache circuit (14, 14′) stores cache lines, state information defining states of the stored cache lines, and flag information for respective addressable locations within at least one stored cache line. The cache control circuit of the first cache circuit (14) is configured to selectively set the flag information for part of the addressable locations within the at least one stored cache line to a valid state when the first processing circuit (12) writes data to said part of the locations, without prior loading of the at least one stored cache line from the background memory (10). Data is copied from the at least one cache line into the second cache circuit (14′) from the first cache circuit (14) in combination with the flag information for the locations within the at least one cache line. A cache miss signal is generated both in response to access commands addressing locations in cache lines that are not stored in the cache memory and in response to a read command addressing a location within the at least one cache line that is stored in the memory (140), when the flag information is not set.

### FIELD OF THE INVENTION

The invention relates to a multi-processing system and to a method of processing a plurality of tasks.

### BACKGROUND OF THE INVENTION

It is known to use cache memories between a main memory and respective processor circuits of a multi-processing circuit. The cache memories store copies of data from main memory, which can be addressed by means of main memory addresses. Thus, each processor circuit may access the data in its cache memory without directly accessing the main memory.

In a multi-processing system with a plurality of cache memories that can store copies of the same data, consistency of that data is a problem when the data is modified. If one processor unit modifies the data for a main memory address in its cache memory, loading data from that address main memory may lead to inconsistency, until the modified data has been written back to main memory. Also copies of the previous data for the main memory address in the cache memories of other processor circuits will be inconsistent.

Prevention of inconsistency may be enforced by the use of a cache protocol. One known cache protocol is the so-called “Modified-Exclusive-Shared-Invalid” (MESI) protocol. This protocol works on the basis of cache lines that each contains a plurality of cache memory locations for data from successive main memory locations. According to the MESI protocol each cache line has an assigned state, which is changed dependent on events relating to the cache line. Such events may be detected by monitoring (snooping) the addresses used by other cache memories to access main memory and signals broadcast by other cache memories.

As the name of the protocol suggests, the states include a “modified” state, an “exclusive” state, a “shared” state and an “invalid” state. The exclusive state is assigned to a cache line when data is loaded from main memory into the cache line and no other cache memory caches this data. The shared state is assigned to the cache line when data is loaded from main memory into the cache line and another cache memory also stores this cache line. If the cache line in the other cache memory is in the exclusive state when this occurs, its state is changed to the shared state. When the cache line is “victimized”, i.e. removed from cache, it is assigned the “invalid” state. This may be done to make room for other data or when it is needed to avoid inconsistency.

In the MESI protocol the “modified” state is assigned to a cache line of a cache memory when data in that cache line is modified by a write operation from the associated processor circuit. A transition to the modified state may be used to trigger assignment of the invalid state to corresponding cache lines in other cache memories. The modified state persists until the cache memory has written back the cache line to main memory.

When write back has been performed, the cache line can be switched from the modified state. However, it may be advantageous not to use immediate write back, in order to avoid a plurality of write backs when a plurality of modifications of data in the cache line is received. The end result of such a plurality of modifications may be written back in a single action. In this case the cache line will be kept in the modified state until the write back.

The modified state has the effect that other cache memories are prevented from independently loading the data for the main memory addresses of the cache line. Instead, action is taken to ensure consistency when an attempt is made to load such data into other cache memories. One solution is to respond to a load attempt from another cache by writing back the modified cache line to main memory, i.e. by exiting from the modified state. When this has been done, the other cache can load the cache line from main memory. A faster solution is to copy the data from the cache line in the modified state to the other cache memories that attempt to load the data, instead of loading the data from main memory. This will be followed later by a write back to main memory.

Various improvements of the MESI protocol have been proposed wherein the range of states that can be assigned to a cache line has been expanded in order to improve cache efficiency. For example, US patent application 2005/27946 has proposed to add an “enhanced modified” state and an “enhanced exclusive” state. Assignment of the “enhanced modified” state signifies to a cache line the same as the “modified” state, plus the fact that a copy of the modified cache line is stored in another cache memory. Assignment of the “enhanced exclusive” state to a cache line signifies that the cache line is in the “enhanced modified” state in another cache memory. These states are used to pass the responsibility for writing back the cache line from one cache to another.

Access operations under the MESI protocol requires that the cache line including the data for the accessed main memory address must be in the cache memory. If the data is not present in cache, a cache miss occurs and the data must first be loaded. This also applies when the access operation is a write operation. This may be advantageous, because it may be likely that data for neighboring addresses in the cache line will be accessed at short temporal distance, so that their availability in cache will speed up processing. In any case it is necessary before the cache line can be assigned the modified state of the MESI protocol, which signifies that the cache line contains the latest data.

However, in only the modified data from the cache line needs to be used. In this case, the need to load data into cache memory before it can be accessed reduces processor efficiency in the case of write operations.

### SUMMARY OF THE INVENTION

Among others, it is an object to increase efficiency of a multi-processing system with cache memories.

A multiprocessing circuit according to claim 1 is provided. This circuit comprises cache circuits with memory for cache lines, state information defining states of the cache lines in the memory, and flag information for respective addressable locations within at least one cache line in the memory. Cache misses are detected both in response to access commands addressing locations in cache lines that are not stored in the memory and in response to a read command addressing a location within the at least one cache line that is stored in the memory, when the flag information indicates an invalid state.

A control circuit of a first cache circuit selectively sets the flag information in the first cache circuit when the first processing circuit writes data to said part of the locations without prior loading of the at least one stored cache line from the background memory. The cache control circuit of the second cache circuit copies data from the at least one cache line from the first cache circuit in combination with the flag information for the at least one cache line. Thus, no cache consistency can be provided for written data without having to read cache lines from background memory.

In an embodiment copying is performed by first forcing the first cache circuit to write back the at least one cache line to main memory, together with a signal derived from the flag information to selectively enable writing of part of the cache line. In this case the second cache may obtain the cache line data and the flag information from the write back. Thus, no additional measures are needed to implement cache to cache copying.

In an embodiment memory space is allocated for a cache line in response to a cache miss without loading data from background memory into the cache in response to the cache miss for a write operation. The data from the write operation is then written to the allocated memory space and the flag information is set to indicate selectively that location or those locations as valid where data from the write command is written. Thus, time lost for loading data from background memory is avoided.

In an embodiment in invalidation signal is generated for a cache miss in the response to a cache miss for a read command when the at least one cache line is in the memory but the flag information indicates the invalid state, by generating an invalidation signal for the cache line. In contrast other cache misses, such as misses due the fact that the cache line is not stored in the cache circuit at all result in read requests. In this way consistent data for read operations is ensured in a simple way.

In an embodiment a special read request is used in the case of a cache miss for the read command when the at least one cache line is in the memory but the flag information indicates the invalid state. The control circuits of the first and second cache circuit copy background memory data obtained by the special read request selectively only to locations that the flag information indicates not to be in the invalid state. Thus, a need to write back data from the cache line to background memory first is avoided.

In an embodiment write back involves write enable signals for respective parts of the contents based on the flag information when the at least one cache line is invalidated and/or evicted. Thus background memory is kept consistent. In an embodiment write strobes for respective parts of a broad data bus may be used for this purpose.

### BRIEF DESCRIPTION OF THE DRAWINGS

FIG. 1 shows a multiprocessor system

FIG. 2 shows architectural aspects of a cache circuit

FIG. 3 shows a flow-chart of cache operation

### DETAILED DESCRIPTION OF EXEMPLARY EMBODIMENTS

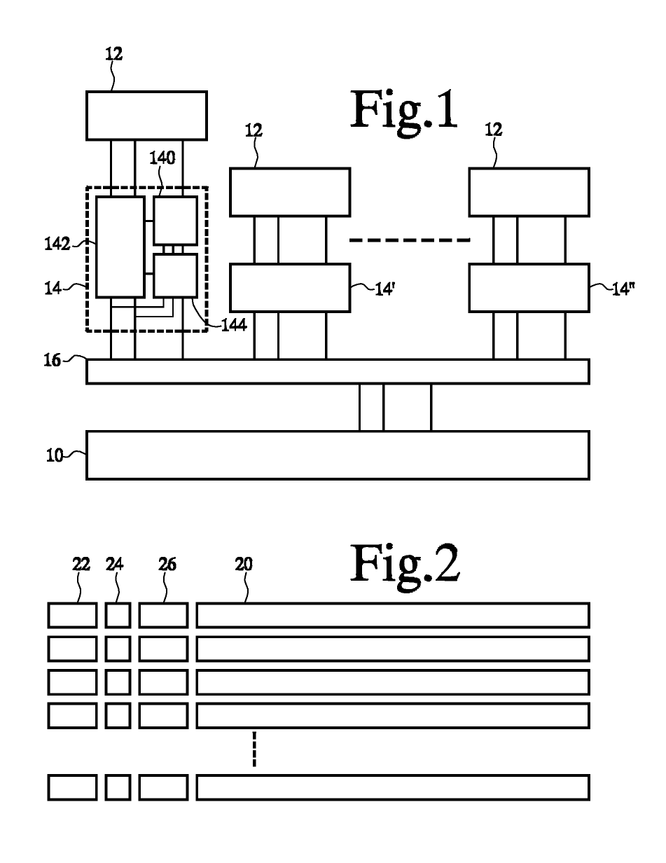

FIG. 1 shows a multiprocessor system, comprising a main memory 10, a plurality of processor circuits 12 and cache circuits 14, 14′, 14″ coupled between main memory and respective ones of the processor circuits 12. A communication circuit 16 such as a bus may be used to couple the cache circuits 14, 14′, 14″ to main memory 10 and to each other. Processor circuits 12 may comprise programmable circuits, configured to perform tasks by executing programs of instructions. Alternatively, processor circuits 12 may be specifically designed to perform the tasks. Although a simple architecture with one layer of cache circuits between processor circuits 12 and main memory is shown for the sake of simplicity, it should be emphasized that in practice a greater number of layers of caches may be used.

In operation, when it executes a task, each processor circuit 12 accesses its cache circuit 14, 14′, 14″ by supplying addresses, signaling whether a read or write operation (and optionally a read modify write operation) is to be performed and inputting and/or outputting data involved in the operation.

Cache circuits 14, 14′, 14″ may have similar structure, and therefore the reference 14 will be used to refer to each in the following, where this makes no difference. One of cache circuits 14 is shown in more detail. This cache circuit comprises a cache memory 140, an address comparison circuit 142 and a control circuit 144. Cache memory 140 is coupled to a data input/output interface of processor circuit 12. Cache memory 140 comprises memory locations for storing cache lines. Address comparison circuit 142 is coupled between an address output of processor circuit 12 and a selection input of cache memory 140. Furthermore address comparison circuit 142 has snoop inputs coupled to a connection from communication circuit. Control circuit 144 is coupled between cache memory 140 and main memory 10, the latter via communication circuit 16. Furthermore control circuit 144 is coupled to address comparison circuit 142. Control circuit 144 may be implemented as a microprocessor circuit programmed to perform the actions described in the following. Instead a logic circuit designed to perform these actions may used, or a lookup circuit.

In operation cache memory 140 stores cache lines with copies of data from main memory 10. Address comparison circuit 142 compares addresses from processor circuit 12 with address information of stored cache lines and generates selection signals to select memory locations in the cache, if it detects that data for the address is stored in cache memory 140 In response cache memory 140 reads and/or writes the data in the selected location.

When address comparison circuit 142 detects that cache memory 140 stores no data for the address, address comparison circuit 142 signals this to control circuit 144. If this happens, control circuit 144 selects memory locations in cache memory 140 for storing a cache line with data for the address. Control circuit 144 supplies information to address comparison circuit 142 to enable it to translate the address into a selection of the memory locations. If the access is a read operation, control circuit 144 first accesses main memory 10 to load a cache line containing the data for the address and stores this cache line in the selected location in cache memory 140.

Address comparison circuit 142 also monitors addresses sent by other cache circuits 14 and compares these addresses with address information of stored cache lines. When address comparison circuit 142 detects that cache memory 140 stores data for such an address, address comparison circuit 142 signals this to control circuit 144. In response the control circuit may modify the state of the cache line, update data in the cache line or invalidate the cache line. This may be done according to the MESI protocol and as described in the following.

FIG. 2 shows architectural aspects of a cache circuit 14. A plurality of cache lines 20 is shown and for each cache line memory locations for an address tag 22, cache line state information 24, and flag information 26. Cache lines 20 are stored in cache memory 140. Address tag 22, cache line state information 24, and flag information 26 may be stored in address comparison circuit 142, but alternatively part or all of this information may be stored in cache memory 140.

Address tag 22 represents part or all of the address that applies to the corresponding cache line 20. It may be noted that the address tag may function in a complex address comparison scheme, such as an n-way associative comparison scheme, in which case it needs to represent only part of the address. In a fully associative scheme a more complete address may be used. As this is not relevant for the further description, no details of the comparison scheme will be described.

Cache line state information 24 represents the state assigned to the cache line 20. This state information distinguishes at least between an exclusive state, an invalid state, a modified state and a shared state. In combination with the flag information the state information, or by itself, the state information may also distinguish a partially valid-modified and a partially-valid shared state. More states may be used. When less than eight states are used, three bits suffice to represent the state, but any representation of the state may be used.

Flag information 26 is provided for respective addressable locations (e.g. bytes, or words) in the cache line 20. Thus, for example if each cache line consists of eight addressable locations, eight flag information items are provided for each cache line and if each cache line consists of sixteen addressable locations, sixteen flag information item are provided for each cache line. Each item may consist of a single bit. The flag information items may be in a set state or a reset state, in which case the flag information for a location will be described as “set” and “reset” (or “not set”) respectively. In the case of flag bits, set may correspond to a binary value one and reset to a binary value zero.

Control circuit 144 is configured to use the cache line state information 24 and flag information 26 to control cache operation. Except in the case of write operations from processor circuit 12 a conventional MESI protocol may be used for a cache line when its state information 24 indicates the exclusive state, the invalid state, the modified state or the shared state.

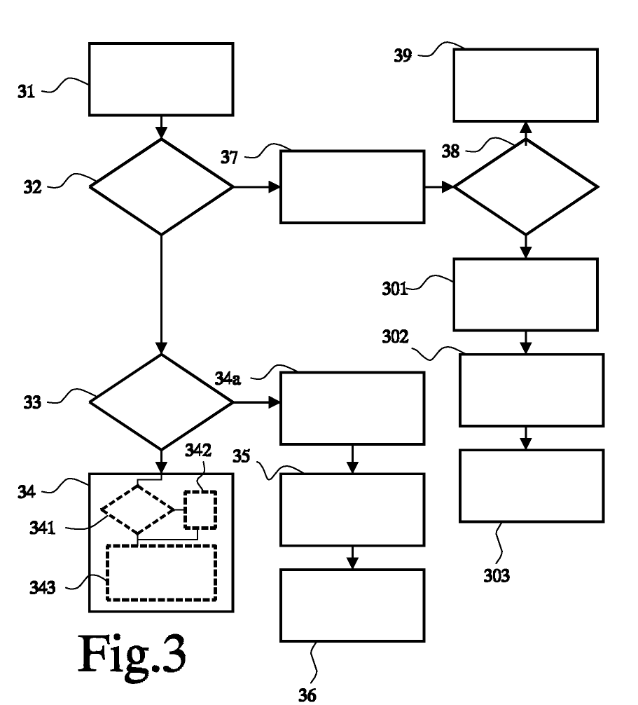

FIG. 3 shows a flow-chart of operation of cache circuit 14. In a first step 31 processor circuit 12 issues an access operation with an address. In a second step 32 comparison circuit 142 detects whether a cache line with the address is stored in cache memory 140. If so comparison circuit 142 executes a third step 33 testing whether the operation is a read operation (Second step 32 and third step 33 may be executed in parallel). In the case of a read operation cache memory 140 performs a fourth step 34, reading and returning the data that it stores for the address. If the operation is a write operation, cache memory 140 writes the data in a memory location for the cache line in alternative fourth step 34a. Still if the operation is a write operation to a cached cache line control circuit 144 performs a fifth step 35 to send an invalidate signal for the cache line to the other cache circuits 14 if the cache line is in the shared state and a sixth step 36 to change the state of the cache line to the modified state.

When second step 32 reveals that no cache line with the data is stored in cache memory 140, control circuit 144 executes a seventh step 37, allocating memory locations in cache memory 140 for a cache line containing the address. This may involve eviction of another cache line. Subsequently control circuit 144 tests whether the operation is a read operation or a write operation. In the case of a read operation control circuit 144 executes a ninth step 39, issuing a request to load the cache line from main memory 10 or, if offered, from another cache circuit 14. Also in ninth step 39 control circuit sets the state of the cache line for example to exclusive or shared, dependent on the source from which the cache line was copied. Subsequently cache memory 140 may proceed with fourth step 34 (connection omitted in the flow-chart).

Thus, on reading a cache line for a particular address from main memory 10 control circuit 144 may set the cache line state information to represent the exclusive state if no signals are received that other cache circuits 14 cache a cache line for that particular address, and to the shared state if one or more other cache circuits 14 cache the cache line for the particular address in the shared or exclusive state. Similarly, control circuit 144 may replace the exclusive state of a cache line for a particular address by the shared state, when control circuit 144 detects that another cache circuit 14 loads the cache line for that address.

When a cache line is “evicted”, e.g. to make room for a cache line for another address or after modification, control circuit sets cache line state information 24 to represent the invalid state. Address comparison circuit 142 tests whether the cache line state information 24 represents the “invalid state”. If so, it will not select the cache line, so that a cache miss may occur for the relevant address.

In parallel, cache circuit 14 also monitors signals from other cache circuits 14. If comparison circuit 142 detects a signal from another cache circuit for an address in a cache line that is stored in cache memory 140, this is signaled to control circuit 144. Dependent on the signal control circuit 144 may evict the cache line or change its state.

Partially Valid Cache Lines

A special action is performed when processor circuit 12 signals a write operation for a write address and address comparison circuit 142 detects that no valid cache line is stored for this write address. Address comparison circuit 142 signals this to control circuit 144. In response control circuit 144 selects a cache memory location for storing a cache line with data associated with this write address, for example by evicting another cache line in cache memory 140. Any known strategy, such as LRU (Least Recently Used) may be used to select such a memory location.

Subsequently, control circuit 144 sets the cache line state information 24 for the selected cache line to represent the modified state. Alternatively, the state information 24 may be set to a special “partially valid-modified” state. Control circuit 144 enables address comparison circuit 142 to select this cache line when the write address is used, e.g. by writing the part of the cache line address into the tag information for the allocated memory locations. The write data of the write operation from processor circuit 12 is stored in the cache line. However, no data from main memory 10 for the cache line is loaded.

It should be appreciated that this means that the data at unwritten in the cache line is actually invalid (i.e. not ensured to be identical to data in main memory 10 or modified by the processor circuit 12), although the invalid state is not set for the cache line. Instead this is indicated by the flag information. The flag bit or flag information for the location or locations where data is written is or are set. The flag information for all other addressable locations in the cache line is reset. Effectively, together with the state information 24, the flag information may indicate that the cache line is in a “partially valid-modified” state. When a cache line is read into cache memory from main memory 10 in its entirety, the flag information 26 may be set for all locations in the cache line. Alternatively, or in addition the state of the cache line may be set to indicate that the cache line is entirely valid.

When processor circuit 12 subsequently writes data to an address associated with a cache line 20 in the modified or partially valid-modified state, the flag information for the addressed location or locations in the cache line is or are set and the write data from processor circuit 12 is stored in these locations. As may be noted this may mean that this part of the data in the cache line is valid, but not known to be equal to the corresponding data in main memory.

When write data is written into the cache line, be it after allocation or subsequently control circuit 144 transmits an invalidate signal for the cache lines with the write address to the other cache circuits 14, so that these cache circuits evict the cache line, if they have it stored. Optionally, this may be omitted if the cache line is in the exclusive state. In response these other cache circuits evict the cache line, if they have it stored.

FIG. 3 illustrates a flow chart of an example of this operation. After eight step 38, when it was detected that a write operation was received for an address in a cache line that was not yet in cache memory 140, control circuit 144 executes a first additional step 301 setting the state information for the cache line to modified or, if available, partially valid-modified. Subsequently, control circuit 144 executes a second additional step 302 sending an invalidate signal for the cache line to the other cache circuits 14.

Next cache memory 140 executes a third additional step 303 writing the data of the write operation into part of the allocated locations for the cache line and setting the flag information 26 for the locations where data was written. Similarly in alternative fourth step 34a, after detecting a write to a previously stored cache line, cache memory 140 sets the flag information 26 for the locations where data was written.

The flag information that was set during writing is used to control execution of read operations for the processor circuit 12. When processor circuit 12 reads data from an address associated with a cache line 20 in the partially valid-modified state, the address comparison circuit 142 tests the flag bit for that address in the cache line (or for a series of addresses if the read operation covers a plurality of addressable locations) and generates a cache miss signal if the flag bit is not set (or any one of the flag information for the series is not set).

The control circuit 144 responds to the cache miss for a cache line in the partially valid-modified state by writing back the data from the cache line to main memory 10, enabling writing only for the data from addressable locations that are marked in the cache line by a set value of the flag bit. Locations for which the flag bit is in a reset state are not updated in main memory 10. A main memory with a plurality of write strobe lines for respective parts of its data lines may be used for example, in which case the flag information is used to control the write strobe lines. Subsequently, control circuit 144 reads back the data from the cache line to main memory 10 and assigns the exclusive or shared state to the cache line.

In the flow chart of FIG. 3 this may be implemented by a fourth step 34 that comprises a sub-step 341 wherein control circuit 144 tests whether the read operation only reads data that is indicated as valid by the flag information 26 before the sub-step 343 of reading (or at least outputting) data from cache memory 140. If any part or all of the data is invalid, control circuit 144 first executes a sub-step 342 to cause the data to be read from main memory 10 into cache memory 140, before enabling cache memory 140 to execute the sub-step of reading the data.

When control circuit 144 decides to evict a cache line, it tests the assigned state of the cache line and performs write back according to the MESI protocol for the conventional MESI states. When the test reveals that the cache line is in the modified state (or the partially valid-modified state, if available) control circuit 144 performs write back on eviction, selectively enabling write back of the data form locations for which the flag information 26 is set and disabling writing of data form locations for which the flag information 26 is not set. This may be done by using a main memory configured to enable writing dependent on the flag information, e.g. with write strobe lines, in which case the control circuit 144 controls the write strobe lines with the flag information. Alternatively control circuit 144 may specifically supply addresses of main memory locations that must be modified.

Eviction of a cache line may occur for example when the control circuit 144 receives an invalidation signal for the cache line from another cache circuit 14. Also control circuit 144 itself may cause eviction, for example when it needs cache memory space for another cache line.

An action with some properties of eviction also occurs when a read cache miss is detected for a specific location in the cache line. This may involve first selectively enabling write back reading back of the modified data in the cache line from main memory and subsequently reading back the entire cache line from main memory. In another embodiment control circuit 144 may perform a read of the cache line from main memory 10 without first writing back the modified data. In this case, control circuit 144 updates data at selected locations in cache memory with data from main memory 10; at locations for which the flags information 24 indicates that the data is not valid. In this case control circuit 144 keeps the cache line in the modified state.

Interaction With Other Cache Circuits

Control circuit 144 monitors requests from other cache circuits 14. When control circuit 144 detects that a request concerns a cache line that is stored in is associated cache memory 140 control circuit may respond to the request. Various types of response may be provided when the cache line is in the partially valid-modified state (indicated by the flag information or a special partially valid-modified state value). In an embodiment control circuit may respond by writing back the modified data of the cache line back to main memory 10, to make it available for the other cache circuit 14. In this case the cache line may be switched to the shared state. In another embodiment the modified data may be communicated directly between the cache circuits 14.

In these embodiments control circuit 144 responds to a read request for a cache line by transmitting the cache line that has been assigned to the partially valid-modified state to the main memory 10 and/or the other cache circuit 14, when the address comparison circuit 142 detects that the read request from another cache circuit 14 has an address in a stored cache line and the cache line has the modified state (or the partially valid-modified state). In this case control circuit 144 also transmits the flag information 26 for the cache line, e.g. via write strobe lines. Optionally, the control circuit only transmits the data from the locations for which the flag bit is set.

The control circuit 144 of the cache circuit 14 that requested this cache line loads the data into the memory locations for the cache line in its cache memory 140 and sets the flag information 26 for the cache line according to the received flag information. In an embodiment, this is done by copying the data and the flag information that is send to main memory from the cache circuit 14 where the cache line is in the modified state. In this case the cache line is effectively in a partially-valid shared state. This may be indicated by the flag information in combination with assignment of the shared state, or optionally by assigning a distinct partially-valid shared state value.

As will be appreciated, copying of partially valid cache lines between cache circuits 14 has the effect that the cache memories 140 may contain copies of the modified data, but with invalid data in the other locations, marked by the flag information.

If the read operation from the cache line addresses a location that is marked as invalid by the flag information 26, the control circuit 144 generates an invalidation signal for the cache line. As described, this will cause the control circuit 144 of the cache circuit 14 that holds the cache line in the partially valid-modified state to write back the valid parts of the cache line to main memory 10. After that the control circuit that requested the read loads the entire cache line from main memory 10. Similarly, on subsequent read operations a cache miss may result if it concerns a location that is marked as invalid by the flag information 26.

In alternative embodiment, control circuit 144 generates a special type of read request instead of an invalidation signal, in response to this type of read miss for a cache line that is in cache, but only partially valid. This may be done to avoid first writing back the cache line. Two detectable types of read request may be used, a normal type of read request when the cache line is not stored in cache memory at all and the special type of read request when it is stored, but with partly invalid data.

The control circuit 144 monitors whether a special type of read request is sent for a cache line for which the flag information indicates part of the data to be invalid. If so, the control circuit 144 selectively copies the data for the locations for which the flag information is not set from the data returned from main memory 10. Thus, valid data is loaded into locations that did not contain valid data. In this case the flag information can be set for all locations in the cache line. This may be done in all cache circuits that store the cache line with partially reset flag information for the cache line.

There are various possibilities of ensuring subsequent consistency and ultimate write back of the modified to main memory 10 in the case of sharing. In principle assignment of the modified state (or partially valid-modified state) to a cache line in a cache circuit 14 implies that that cache circuit has responsibility for write back of the modified data to main memory 10. When this responsibility has been fulfilled, the cache line may be switched to another state. In one embodiment the full responsibility always remains with the cache circuit 14 that first placed the cache line in the modified state (or partially valid-modified state).

In other embodiments the responsibility for ensuring consistency and/or write back may be partly or entirely shifted between cache circuits. In the embodiment wherein the responsibility for a cache line is shifted, the control circuit 144 of the cache circuit 14 that requested this cache line and received it from the cache circuit 14 where it was in the modified state (or the partially valid-modified state) may subsequently sets the state of this cache line to the modified state (or the partially valid-modified state). In this case the original cache circuit may be signaled switch the cache line from the modified state. In an embodiment this may be done by sending an invalidate signal for the cache line to the original cache circuit 14. These actions may be taken for example when a write operation from the processor circuit 12 is detected to a cache line in the shared state with partially valid data in the cache line.

Thus some rights and responsibilities may be shifted between cache circuits 14. For example, on detection of a write operation to a cache line in the partially valid-shared state, the control circuit 144 may allow the write, set the flag information for the locations where data is written and send an invalidate signal for the cache line to the other cache circuits. In this case the control circuit may accompany this by switching the cache line to the partially valid-modified state.

Although the operation of cache circuit 14 has been described in terms of the actions taken, it should be understood that this method operation can be translated directly into configuration of the cache circuit 14, for example into instructions of a computer program of control circuit 144 to perform the actions, and/or into logic circuits that cause the actions to be performed under the specified circumstances.

It should be appreciated that various alternative embodiments are possible. Although embodiments have been described wherein flag information is kept for all stored cache lines, it should be appreciated that instead flag information may be kept for only one stored cache line or part of the cache lines. In this case the other cache lines may be treated according to a conventional MESI protocol, loading the entire cache line into cache memory 140 if it is not in cache memory 140 when data has to be written from processor circuit 12.

Effectively this means that the flag information is implicitly assumed to be set for all locations in such cache lines. In this case any signals that are controlled by the flag information in the case of cache lines with flag information may be supplied as if the flag information was set for the cache lines without flag information.

In an embodiment state information 24 only represents MESI state values (modified, exclusive, shared and invalid), in which case control circuit 144 performs a test of the flag information for a cache line when distinct actions are needed dependent on whether all data is valid. Alternatively, additional state values may be used to indicate presence of partially valid data. In this case control circuit 144 may first test whether or not the state information for a cache line indicates such an additional state. This may remove the need to test the individual flag information items. The representation of the additional state by also be part of the flag information, for example in the form of a single bit that applies to the cache line as a whole. This bit may be considered part of one or both of the flag information 26 and the state information 24. The flag information 26 and the state information 24 may overlap.

In an embodiment the responsibility for write back of the partially valid cache line may be partially shifted between cache circuits after the cache line has been copied between cache circuits. In an embodiment this may be implemented by providing for additional information to distinguish between data modified by the cache circuit and data modified by other cache circuits and subsequently copied. In this case, each cache circuit may be configured to enable write back to memory only for data flagged as the result of modification in the cache circuit.

In an embodiment this may be implemented by providing for additional information to indicate a number of cache circuits in which copies of a partially valid cache line are stored. In this case, the control circuit 144 updates the additional information each time when it detects that the cache line is copied to another cache circuit and each time when it detects that the cache line is evicted from another cache circuit. In this embodiment, the control circuit 144 writes back the cache line, selectively enabling modified locations, when it evicts the cache line from the cache circuit, provided that the additional information indicates that the cache circuit is the only one that (still) stores the cache line.

In a further embodiment the additional information may merely indicate whether the cache circuit is the only one to store the cache line or not. In this embodiment the responsibility for write back may remain with the first two cache circuits that stored copies of the cache line.

Although embodiments have been described that are applicable to single level caching, it should be appreciated that similar techniques can be applied to multi-level caches. Also, although embodiments with a main memory 10 have been described, it should be appreciated that any common background memory may be used instead.

Furthermore, although it is preferred that the cache circuit of the same design are used for all processing circuits, each allowing for partial valid cache lines, it should be appreciated that alternatively only part of the cache circuits may provide for partial validity, the other following a normal MESI protocol. Thus for example, one cache circuit may allow write to a cache line without data from memory, accompanied by flag setting, while another cache circuit may provide for copying the flag information and detecting cache misses using the flag information, even if both caches do not have both abilities. Some processing circuits may be even be provided that have no cache at all. As will be noted this may necessitate write back of data from partially valid cache lines to main memory when the data is accessed by such processor circuits.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A multiprocessing circuit with an interface to a background memory, a first and a second processing circuit and a first and a second cache circuit coupled between the interface and the first and the second processing circuit respectively, the first and the second cache circuit each comprising:
a memory for cache lines, state information defining states of the cache lines in the memory, and flag information for respective addressable locations within at least one cache line in the memory;
a cache hit and miss detection circuit coupled to the memory and to the processing circuit for receiving access commands, the cache hit and miss detection circuit being configured to generate cache miss signals in response to access commands addressing locations in cache lines that are not stored in the memory and to a read command addressing a location within the at least one cache line that is stored in the memory, when the flag information indicates an invalid state;
a cache control circuit coupled to the cache hit and miss detection circuit, the memory and the background memory interface, wherein the cache control circuit of the first cache circuit is configured to selectively set the flag information in the first cache circuit for part of the addressable locations within the at least one stored cache line to a valid state when the first processing circuit writes data to said part of the locations, without prior loading of the at least one stored cache line from the background memory, the cache control circuit of the second cache circuit being configured to copy data from the at least one cache line from the first cache circuit in combination with the flag information for the at least one cache line.

2. A multiprocessing circuit according to claim 1, wherein the control circuit of the second cache circuit is configured to generate a read request for a missing cache line, and wherein the first cache circuit is configured to detect the read request and to cause its control circuit to generate a transmission of information dependent on the at least one cache line, in combination with the flag information, upon detection that the read request has a request address matching an address of the at least one cache line, the control circuit of the second cache circuit being configured to derive the cache line and the flag information from said transmission.

3. A multiprocessing circuit according to claim 2, wherein the control circuit of the first cache circuit is configured to generate said transmission as a write command to the background memory, with contents of the at least one cache line as write data and write enable signals for respective parts of the contents derived from the flag information.

4. A multiprocessing circuit according to claim 1, wherein the control circuit of the first cache circuit is configured to allocate memory space in the memory for the at least one cache line in response to a cache miss for a write command from the first processor circuit with an address in the at least one cache line, when said at least one cache line is not in the memory of the first cache circuit, to enable writing from the first processing to the allocated memory space without first copying a current content of the cache line from the background memory, and to set the flag information to indicate selectively that location or those locations as valid where data from the write command is written.

5. A multiprocessing circuit according to claim 1, wherein the control circuit of the second cache circuit is configured to respond to a cache miss for the read command when the at least one cache line is in the memory but the flag information indicates the invalid state, by generating an invalidation signal for the cache line and to other cache misses by generating read requests.

6. A multiprocessing circuit according to claim 1, wherein the control circuit of the second cache circuit is configured to respond to a cache miss for the read command when the at least one cache line is in the memory but the flag information indicates the invalid state by generating a special read request for the cache line, distinguished from normal read requests for other cache misses, the control circuits of the first and the second cache circuit being configured to respond to copy background memory data obtained by the special read request selectively only to locations that the flag information indicates not to be in the invalid state, and to set the flag information for those locations.

7. A multiprocessing circuit according to claim 1, wherein the control circuit of the first cache circuit is configured write back the at least one cache line with contents of the at least one cache line as write data and write enable signals for respective parts of the contents derived from the flag information when the at least one cache line is at least one of invalidated and evicted.

8. A method of processing data using a first and a second processing circuit coupled to a background memory via a first and a second cache circuit respectively, the method comprising:
storing, in each cache circuit, cache lines, state information defining states of the stored cache lines, and flag information for respective addressable locations within at least one stored cache line;
selectively setting the flag information in the first cache circuit for part of the addressable locations within the at least one stored cache line to a valid state when the first processing circuit writes data to said part of the locations, without prior loading of the at least one stored cache line from the background memory;
copying data from the at least one cache line into the second cache circuit from the first cache circuit in combination with the flag information for the locations within the at least one cache line; and
signaling a cache miss signal both in response to access commands addressing locations in cache lines that are not stored in the memory and in response to a read command addressing a location within the at least one cache line that is stored in the memory, when the flag information is not set.
